(19) United States
(12) Patent Application Publication
(10) Pub. No.: US 2026/0087645 A1
(43) Pub. Date: Mar. 26, 2026

(54) Bandwidth Reduction in A Motion Tracking Apparatus

(71) Applicant: Topgolf International, Inc., Dallas, TX (US)

(72) Inventors: Stein Norheim, Stockholm (SE); Xinyi Zhang, Tyreso (SE)

(73) Assignee: Topgolf International, Inc., Dallas, TX (US)

(21) Appl. No.: 19/331,689

(22) Filed: Sep. 17, 2025

Related U.S. Application Data
(60) Provisional application No. 63/699,037, filed on Sep. 25, 2024.

(51) Int. Cl. G06T 7/246

(52) U.S. Cl. CPC G06T 7/246; G06T 2207/20021; G06T 2207/20221

(57) ABSTRACT

A method and system for bandwidth reduction in a motion tracking apparatus are disclosed herein. The system includes an image sensor and a computing apparatus in communication with the image sensor. The method splits an input image into a 2x2 binned representation and a native-pixel clipped image, then applies a statistical noise modelling on each of them separately and then combines the results into one combined list of interesting points. The invention achieves a 50% reduction of bandwidth, neither sacrificing the launch precision or the distant resolution.

### CROSS REFERENCES TO RELATED APPLICATIONS

The Present Application claims priority to U.S. Provisional Patent Application No. 63/699,037, filed on Sep. 25, 2024, which is hereby incorporated by reference in its entirety.

### STATEMENT REGARDING FEDERALLY SPONSORED RESEARCH OR DEVELOPMENT

Not Applicable

### BACKGROUND OF THE INVENTION

### Field of the Invention

The present invention relates to a motion tracking of objects.

### Description of the Related Art

In order to track objects, it is common to use a sensor, such as a camera, a radar or the like, to capture a sequence of images of a moving object. When the sensor is used to track one or more moving objects, a tracking program in a computer is usually used. The tracking program can distinguish signals, originating from tracked objects, from other signals, such as static objects and noise, in the image captured by the sensor. This is typically done by either using a fixed noise threshold for the signal, or by using an adaptive method that uses statistics to set the sensor itself.

One difficulty with this approach is that there can be other objects or external environmental conditions that cause other, stronger, signals to be present in the image data from the sensor. For example, if the sensor is a camera, and the environment is a grass field in a suburban area, traffic, cars and headlights might result in very strong signals in the image data from the camera. Disadvantageously, this can make it difficult to track objects in the image. Furthermore, if it is raining or snowing, such weather conditions can cause hundreds or thousands of relatively strong signals in the image data at the same time.

When the number of pixels emitted by an image sensor is larger than what can be transmitted given the available bandwidth, common mitigations could be to either lower the frame rate, reducing the image precision or reducing the resolution. All these strategies remove information in some form and each of them comes with tradeoffs.

2×2 Binning—Groups of 2×2 pixels are averaged to form new pixels. This effectively reduces the size of a single frame by 75% since 4 pixels become 1. The average pixels are also less subject to random read-out noise since the contribution of each pixel is only ¼ of the total pixel value. Golf balls that are far away might be harder to track in a lower resolution.

Reduced framerate—Frames are captured less often. Since there are fewer opportunities to observe the object being tracked, the contribution of an error in an individual observation will be higher.

Reduced bit-depth—Many sensor provide 12 bits of precision for each pixel. If this is reduced to 10 bits, less information needs to be transmitted, but at the expense of the dynamic precision in the image.

Region of interest (ROI)—Clip the image so only a part of the view is transmitted. This keeps full detail and framerate, but at the expense of reducing the area that can be seen.

Objects close to the camera are typically larger and move “faster” over the two-dimensional frame. At the same time, a distant object moving at the same 3d velocity would look much smaller in the camera and have a slower movement across the image frame. The tradeoff between resolution and framerate is hard, since it is BOTH important to observe the ball right after the shot impact and to see it as far as possible. The early observations determine the launch angle, velocity and spin, as well as help us extrapolate the trajectory back to the bay. The distant observations are important since the player wants to know where the ball landed, and higher resolution gives better visibility.

### BRIEF SUMMARY OF THE INVENTION

The current process is separating moving objects from a static background.

This invention proposes splitting the input image into a 2×2 binned representation and a native-pixel clipped image, applying the statistical noise modelling on each of them separately and then combining the results into one combined list of interesting points.

By using 2×2 binning and ROI in combination, the present invention achieves a 50% reduction of bandwidth, neither sacrificing the launch precision or the distant resolution.

One aspect of the present invention is a method for bandwidth reduction in a motion tracking apparatus. The method includes generating, at an image sensor, an input frame of an object in motion. The method also includes splitting the input frame into a 2×2 binning fame and a Region Of Interest (ROI) frame. The method also includes transmitting 2×2 binning frame to a computing apparatus. The method also includes transmitting the ROI frame to the computing apparatus. The method also includes noise modelling the 2×2 binning frame to generate a binned blobmap. The method also includes noise modelling the ROI frame to generate a ROI blobmap. The method also includes merging the binned blobmap with the ROI blobmap to generate a combined blobmap. The method also includes aggregating the combined blobmap to determine a list of blobs in the input frame. The method also includes tracking the motion of the object based on the list of blobs in the input frame.

Another aspect of the present invention is a system for bandwidth reduction in a motion tracking. The system includes an image sensor and a computing apparatus in communication with the image sensor. The image sensor is configured to generate an input frame of an object in motion. The image sensor is configured to split the input frame into a 2×2 binning fame and a Region Of Interest (ROI) frame. The image sensor is configured to transmit 2×2 binning frame to the computing apparatus. The image sensor is configured to transmit the ROI frame to the computing apparatus. The computing apparatus is configured to noise model the 2×2 binning frame to generate a binned blobmap. The computing apparatus is configured to noise model the ROI frame to generate a ROI blobmap. The computing apparatus is configured to merge the binned blobmap with the ROI blobmap to generate a combined blobmap. The computing apparatus is configured to aggregate the combined blobmap to determine a list of blobs in the input frame. The computing apparatus is configured to track the motion of the object based on the list of blobs in the input frame.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a schematic overview of an example of a system.

FIG. 2 is an exemplifying illustration showing regions of an environment captured by an electromagnetic sensor.

FIG. 3 is a flowchart.

FIG. 4 is a flow chart.

FIG. 5 is a block diagram illustrating embodiments of the computing apparatus.

FIG. 6 is an image using 2×2 binning and ROI in combination.

FIG. 7 is an image of a driving range where the binned and clipped images are combined into one.

FIG. 8 is an enlarged image of FIG. 7 illustrating the difference in detail between the two resolutions.

FIG. 9 is a block diagram of a standard segmentation algorithm.

FIG. 10 is a block diagram of splitting and recombination modified segmentation algorithm.

FIG. 11 is an illustration of the binned cells.

FIG. 12 is a flowchart for a method for bandwidth reduction in a motion tracking apparatus.

FIG. 13 is a block diagram for a system for bandwidth reduction in motion tracking.

### DETAILED DESCRIPTION OF THE INVENTION

As an example of methods for tracking moving objects using one or more cameras depicting a space where the moving objects exist, it may be that the tracking is performed by first identifying an object as one image pixel, or a set of adjacent pixels, that deviate from a local background. This is often referred to as blob detection. Once a number of blobs have been detected in several image frames, possible tracked object paths are identified by interconnecting identified blobs in subsequent frames. This is often referred to as a tracking procedure.

The blob generation in each individual frame potentially results in very many false positive blobs, in other words, identified blobs that do not really correspond to an existing moving object. This may be due to noise, shifting lighting conditions and non-tracked objects occurring in the field of view of the camera in question.

The detection of possible tracked object paths normally results in a reduction of such false positives, for instance based on filtering away of physically or statistically implausible paths. Due to the large number of false positive blob detections, however, even if most of the false positives are filtered away in the tracked paths detection step, the blob detection itself is associated with heavy memory and processor load and may therefore constitute a bottleneck for the object tracking even if high-performance hardware is used.

Moreover, as the performance of digital cameras increases, pixel data output from such cameras increases correspondingly. In order to achieve accurate tracking of moving objects, it is desired to use as accurate and precise image information as possible.

Blob detection and/or tracking procedure are known from US Patent Publication Number 20220051420 and 20220138969, which are each hereby incorporated by reference in their entireties.

Since it is normally desired to avoid too many non-detected blobs (false negatives), leading to potentially missed tracked object paths, a relatively large share of false positive blob detections can be accepted.

A sensor has a field-of-view (FoV), i.e., a portion of the environment observed. A sensor can be a radar, a camera, a lidar, etc. The present inventors have observed that in many cases, the noise level will not be constant throughout the FoV, but instead it will vary depending on where in the FoV the noise level is measured. Furthermore, the Signal-to-Noise Ratio (SNR) for the moving object to be tracked may also vary, depending on the position of the object in the sensor's FoV.

Specifically in the case of a camera, different parts of the image from the camera may have different levels of noise, different expected SNRs and different characteristics of the noise. If the objective is to track a moving object or projectile, it is also expected that the signal has different characteristics, such as SNR or the like, in different parts of the image, depending on how the camera is located and aimed compared to the distance to the object to be tracked, and to the direction of movement of the tracked object.

When tracking objects, a difficulty is how to find the first observation of the object, or the first two or three observations. This may sometimes be referred to as a launch, or start, of the path. A reason for the difficulty in finding the first observation is that any signal detected above the noise threshold can be a first observation, such as a so called blob or the like. The second observation is also difficult to evaluate, since in that case there is only one observation to base a prediction upon. When no assumptions can be made about the direction, in case only the first observation has been obtained, all subsequent observations sufficiently close to the first observation need to be considered to be candidates for becoming the second observation. As a result, a lot of computing resources are required to identify possible launches, or starts, of new objects' paths.

As used herein, the term “observation” may be a blob. The observation may refer to a location of interest in an image frame. The location may be of interest, e.g., due to that the location, or set of pixels, are outside a noise level, e.g., compared to a preceding image frame. The set of pixels, i.e., one or more pixels, are a continuous collection of pixels in that each pixel of the set is directly adjacent to at least one other pixel in the set. An observation, or set of data points, can be an actual observation, e.g., obtained by blob detection, or an extrapolated observation, e.g., obtained based on existing blobs of a particular path. The term “blob” may thus refer to any set of directly adjacent pixels that have been identified as changed from one image frame to another image frame and that are not considered to be noise, e.g., are outside, or above, a noise threshold. As mentioned, it is sufficient that each pixel of the set is directly adjacent to at least one other pixel of the set.

The expression “launch”, or “start”, have been used interchangeably and refers to a path with only one, or few, observations.

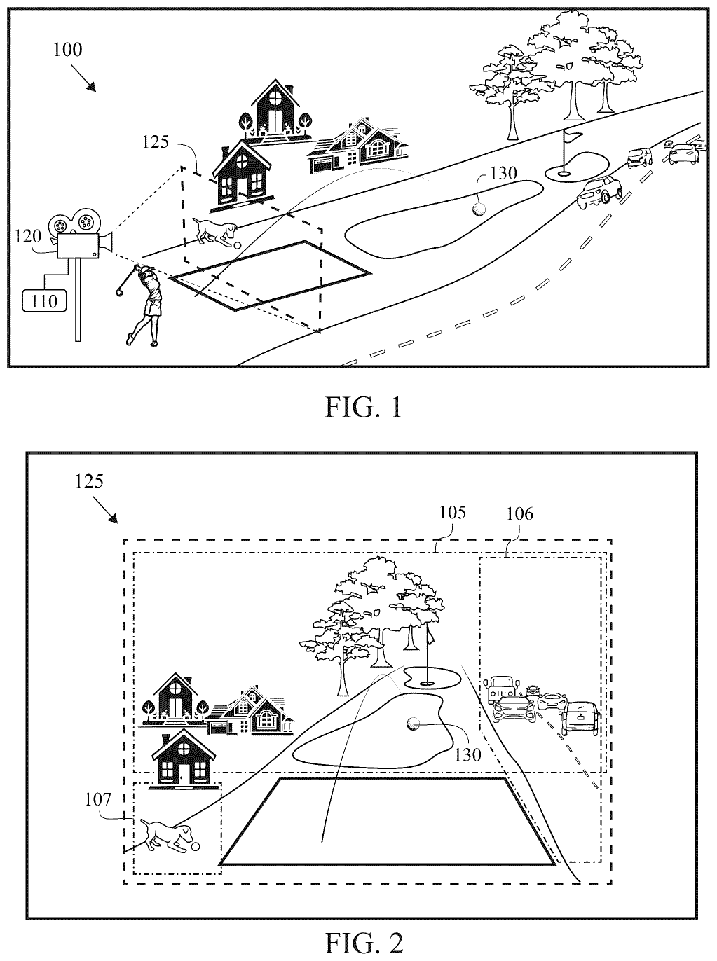

FIG. 1 illustrates a system 100 for bandwidth reduction in motion tracking. The system 100 includes an image sensor 120 and a computing apparatus 110 in communication with the image sensor 120 three-dimensional environment, including a portion of a sports area. The sports area is surrounded by surrounding areas, such as housing areas, traffic areas, bush areas, or the like. The sports area can be a golfing area, a golf course, a driving range, a soccer field, a tennis court, a football field, a table tennis court, or the like.

In a typical setup for tracking of a golf ball 130 that is shot from a location in the golfing area, an electromagnetic sensor 120 for tracking of the golf ball is provided. This means for example that the electromagnetic sensor 120 is arranged, such as mounted, installed, or the like, to capture a portion of the golfing area, e.g., in a so-called field of view of the electromagnetic sensor 120. The electromagnetic sensor 120 can include an imaging device configured for capturing a sequence of images forming a video, a video recorder, a digital video recorder, a camera, a digital camera, an imaging device, an image sensor, a radar sensor, a radar device, a combination thereof or the like. More explicitly, this means that the electromagnetic sensor 120 may be, or be embodied as, any one of the aforementioned examples that represent electromagnetic sensors having a field of view.

The portion of the sports area, e.g., the golfing area, is thus located in a field of view (FoV) 125 of the electromagnetic sensor 120. The field of view is represented by, or projected onto or the like, an array or matrix of pixels of the electromagnetic sensor 120. The pixels may be sensitive to electromagnetic radiation of various types, such as light, visible light, X-ray, radar, ultraviolet light and more. When the electromagnetic sensor 120 captures an image, the image will be a two-dimensional (2-D) representation of the portion of the golfing area that is located within the electromagnetic sensor's field of view 125.

The term “field of view of the electromagnetic sensor” may refer to a field of view of an image sensor of the camera, a field of view of a radar sensor or the like. Sometimes, the terms “FoV” and “image” may be used interchangeably.

A path may be defined by a set of observations, such as blobs. The blobs may be detected in images captured by the electromagnetic sensor 120. Each blob, or observation, may have a position, a size, and brightness level. The position, e.g., in at least two-dimensions, is, at least initially, in the coordinate system of the electromagnetic sensor. The size may refer to e.g., width and height of the blob. The brightness level may be an average of the pixels of the blob or any other aggregated measure of the brightness of the pixels in the blob.

As used herein, a path refers to a sequence of two-dimensional coordinates of observations, a sequence of observations, or a sequence of blobs, that may represent the movement of an object along a trajectory, projected in the image plane. Most paths that are constructed in the early stages of tracking are false positives that can be eliminated in later stages, or never become sufficiently long to be assumed as belonging to an actual sports projectile.

As used herein, the term “image” refers to a two-dimensional representation of a field of view of an electromagnetic sensor. An image can thus comprise information captured by e.g., cameras, radars, image sensors, or the like. In some examples, the image is represented by a matrix of pixels of a 2-D image sensor.

Once the setup has been completed, it may be that tracking of the golf ball is less accurate in some regions of the field of view 125. For this reason, a person may define at least one region 105, 106, 107 that pertains to a portion of the field of view 125 of the electromagnetic sensor 120. See the exemplifying regions 105, 106, 107 in FIG. 2. The person may be an operator, a user, a human, a golf player, a golfing area employee, or the like.

By allowing the person to define the shapes of the region(s) directly in a visualization of the sensor input, it's much easier for the person to reason around which conditions to apply, and the exact extent of the region(s) marked, such as defined, or the like.

In addition, the person may define, e.g., in case there is only one region, a region tracking condition for application to the tracking of the object 130 in the region. In more detail, the region tracking condition may be applied to the observation(s) in the region, or in some examples to path(s) entering the region. As an example, in case of multiple regions, the person may define a respective region tracking condition for each region of said multiple regions. One or more of the respective region tracking conditions may be the same, or similar. Likewise, one or more of the respective region tracking conditions may be different from each other. Moreover, one or more regions may overlap, or may not overlap, with each other.

This means for example, in a case with three regions, that there can be a first region, a second region and a third region. Purely as an example, the first region can be at least partly overlapping with the second region and the third region may not be overlapping with any one of the first and second regions. Still purely as an example, the first region can be associated with a first region tracking condition, the second region can be associated with a second region tracking condition, and the third region can be associated with a third region tracking condition. Continuing of the purely exemplifying description, the first region tracking condition can be the same as, or similar to, the third region tracking condition, while e.g., the second region tracking condition can be different from the first and third region tracking conditions. As already mentioned, each region can be associated with one or more region tracking conditions. Thus, as a further purely illustrative example, it can be that the three regions can be associated with a common region tracking condition that is applicable to all of the first, second and third regions and that the three regions are further associated with a respective region tracking condition, where each respective region tracking condition is unique for the corresponding region. In this example, it means that each region is associated with two region tracking conditions, where one region tracking conditions is the common region tracking condition that is the same for all the three regions.

In view of the above, there is provided exemplifying methods for managing tracking of the object 130 moving in the three-dimensional environment 100, where different, or same, region tracking conditions are applied to the tracking, e.g., including starts, continued movement or the like. Furthermore, in some embodiments, the observation(s) can be processed, such as filtered, compared to region tracking condition(s), or the like, based on e.g., direction and/or position in the FoV of the observation.

As a general overview, it may be noted that the exemplifying methods herein can include the following main actions. The operator identifies a region in the FoV of the electromagnetic sensor where the external environment measured by the electromagnetic sensor exhibits characteristics that may cause a tracking algorithm to have a high failure rate within that region. The region can be marked geometrically by the operator, for example in the shape of a polygon, such as a rectangle, triangle, irregular polygon, or the like. The operator can place corners of a region, either by specifying their coordinates in the image (or other relevant coordinate system for the sensor), or by clicking in a user-interface representing the image in order to create the regions. If the user-interface representing the image can show noise levels in the image, as well as the objects being tracked, it's possible for the operator to identify regions in the image where noise levels are high, or regions where object tracking is difficult, and then mark these regions. A region tracking condition is defined for the identified region. The region tracking condition can be an instruction to apply a different noise threshold level, restrictions on the direction of a velocity vector that a tracked object can have, or that tracking should be suspended completely within the area, or some other condition as described in more detail herein. The region tracking conditions may predefined, or the operator may possibly adjust/generate/create conditions dynamically, e.g., on the go. With the method herein, an observation, or typically a set of observations, is evaluated toward the region(s) as defined in 1 and the corresponding region tracking condition(s) as defined in 2. When an observation is considered for being added to a path, the new path with the candidate observation is tested against these criteria. Then, the observation is either kept or prevented from being added to the path, based on the result. When the observation is kept, it can be included in the path for which tracking is continued. When the observation is discarded, either only the present observation will be discarded from the path, or the present path will be discarded and thus not included in continued tracking. An observation that has been rejected from one path might still be accepted into one or more other paths.

Some embodiments provide a flexible and versatile solution for application of region tracking conditions, e.g., in terms of shapes of the region in which the region tracking condition shall be applied, in terms what region tracking condition that may be applied. The shape of the region(s) can include polygonal shape, rectangular shape, triangular shape, circular shape, irregular shapes formed by a number of curves, free form shape(s), or the like. Notably, at least some of the region tracking conditions herein make use of the person's knowledge about the object's expected motion behavior, e.g., in a specific region.

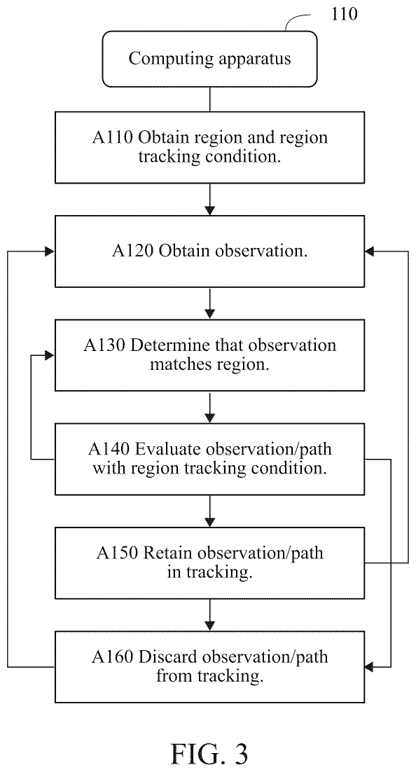

FIG. 3 shows an exemplifying method for managing tracking of the object 130 moving in the three-dimensional environment 100. As an example, the computing apparatus 110 performs the method for managing tracking of the object 130 moving in the three-dimensional environment 100.

In action A110, the computing apparatus 110 obtains, such as receives, reads, fetches or the like, an indication of a region 105, 106, 107 and a region tracking condition, which is to be applied to the tracking of the object 130 in the region 105, 106, 107. The region 105, 106, 107 pertains to a portion of the field of view 125 of the electromagnetic sensor 120 for tracking of the object 130 in the three-dimensional environment 100. The indication of a region may be referred to as a region indication. In some examples, the computing apparatus 110 can obtain a list of region indications and corresponding region tracking conditions. The region indication(s) and the region tracking condition(s) may be predetermined or dynamically determined, e.g., by the person.

In some examples, the indication of the region 105, 106, 107 and the region tracking condition may be obtained by the person inputting the indication of the region 105, 106, 107 and the region tracking condition, e.g., directly into the computing apparatus 110 or via another device, such as a PC, smartphone or the like.

In some examples, the computing apparatus 110 can receive, such as read, fetch or the like, the indication of the region 105, 106, 107 and the region tracking condition from a memory, such as an external or internal memory. An external memory can be external to the computing apparatus 110, such as a portable drive, a remote memory, a cloud storage or the like. An internal memory can be internal, e.g., within a casing of the computing apparatus 110, such as a hard drive, a disc drive, a persistent computer memory or the like.

In some embodiments, the obtaining A110 comprises obtaining a further indication of a further region 105, 106, 107 and a further region tracking condition to be applied to the tracking of the object 130 in the further region 105, 106, 107, wherein the further region 105, 106, 107 pertains to a portion of the field of view 125.

In some embodiments, the region 105, 106, 107 partially overlaps with the further region 105, 106, 107 and both of the region 105, 106, 107 and the further region 105, 106, 107 cover less than all of the field of view 125.

In some examples, the regions 105, 106, 107 may be determined by the user. Accordingly, as above, the region(s) and/or the further region(s) 105, 106, 107 can be received as user input, e.g., input by the person, e.g., using a keyboard, a mouse or the like.

Similarly, in some examples, the region tracking condition may be determined by the user. Accordingly, as above, the region tracking condition(s) and/or the further region tracking condition(s) can be received as user input, e.g., input by the person, e.g., using a keyboard, a mouse or the like.

In action A120, the computing apparatus 110 obtains an observation relating to the tracking of the object 130. The observation is generated based on at least one two-dimensional representation of the field of view 125, wherein said at least one two-dimensional representation has been captured by the electromagnetic sensor 120, such as at least one image. Said at least one image can e.g., include two or more images. The observation is includable in a set of observations defining a path of the object 130 in the field of view 125. The aforementioned documents relating to known tracking procedures provides some examples on associating an observation with a path, e.g., a new path or a continuation of an existing path. The observation can be a blob, a pattern, or the like. In practice the computing apparatus 110 can obtain hundreds or thousands of observations from each image. Most of the observations are false positives, i.e., observations that do not actually originate from one or more moving sports projectiles. Of course, some of the observations can be true positives, i.e., observations that in fact originate from one or more moving sports projectiles. False positive observations can be noise, branches of a tree that move in the wind, etc. The computing apparatus 110 can obtain the observation by applying any commonly known blob detection procedure, such as a blob detection procedure based on differential, spatio-temporal, and grey-level characteristics in the captured images, on filtering, on masking or the like.

The computing apparatus 110 determines that the observation matches the region 105, 106, 107. This action A130 can refer to that the computing apparatus 110 can check whether the observation, e.g., a position of the observation in the FoV matches the region, e.g., is in the region. The position of the observation can be given as an explicit point, having a pair of coordinates, in the image. The explicit point can be a center point of the observation, an upper left point of the observation, a lower left point of the observation, a lower right point of the observation, an upper right point of the observation or the like. The point can then be either inside or outside of the region. If the point is on a border of the region, it can be consistently determined to be either inside or outside of the region. In this manner, the matching avoids unclear outcomes in case, an area of the blob reaches into, or partly covers, multiple regions. In case the observation does not match the region, the computing apparatus 110 can proceed with any existing further region tracking condition as will be described in more detail below.

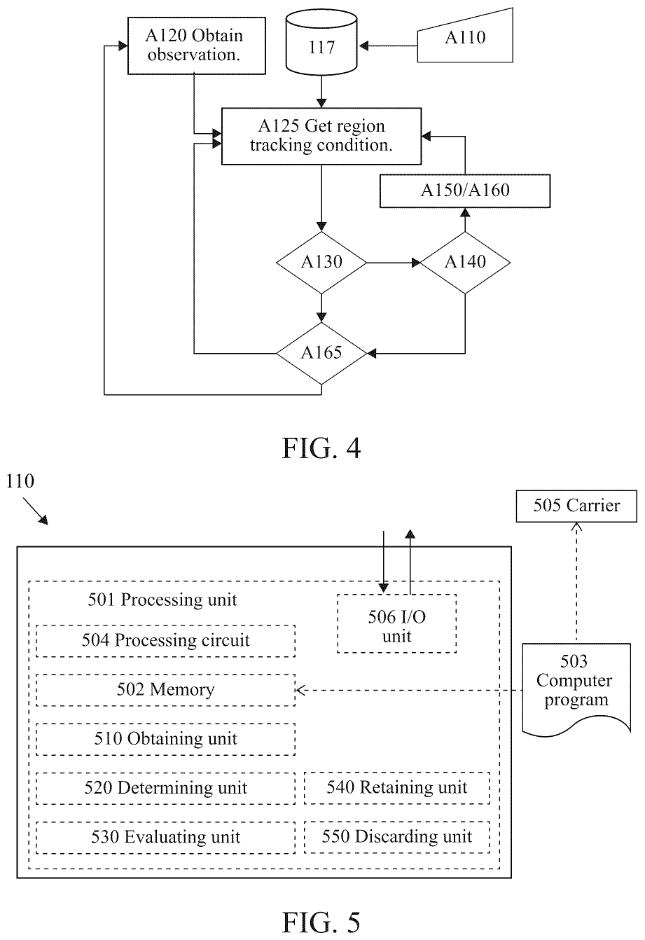

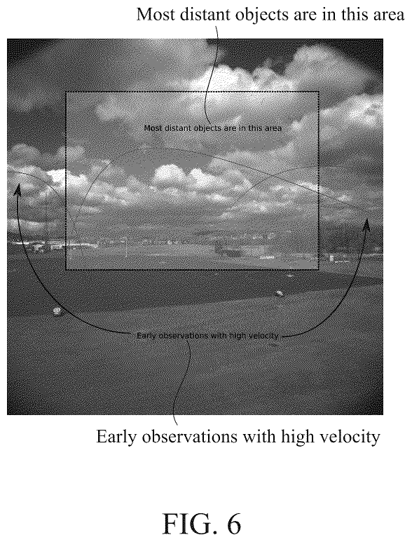

In an evaluation action A140, the computing apparatus 110 evaluates whether the observation and/or the path fulfills the region tracking condition of the, region 105, 106, 107 or not. The region tracking condition can apply to the observation, the path or both. This action A140 may refer to that the computing apparatus 110 can determine that the observation and/or the path fulfills the region tracking condition. Alternatively, as described in connection with FIG. 4, the method may return to action A130 in order to evaluate any existing further region(s) and any existing further region tracking condition(s).

In action A150, the computing apparatus 110 retains, based on the evaluation action A140, the observation and/or the path in continued tracking of the object 130. The expression “based on the evaluation action A140” may e.g., mean that the computing apparatus 110 retains the observation and/or the path in continued tracking when the observation and/or path fulfills the region tracking condition, or as the case may be when the observation and/or path fails to satisfy the region tracking condition. In some examples, it may be described as that the evaluation concerns whether or not the observation is allowed to be added to a path, e.g., with respect to the currently evaluated region tracking condition.

The computing apparatus 110 discards A160, based on the evaluation action A140, the observation and/or the path from continued tracking of the object 130. The expression “based on the evaluation action A140” may e.g., mean that the computing apparatus 110 discards the observation and/or the path from continued tracking when the observation and/or path fails to satisfy the region tracking condition, or as the case may be when the observation and/or path fulfills the region tracking condition.

Typically, only one of action A150 and A160 is performed, e.g., for each region in case of evaluation of multiple regions and for each observation, e.g., when multiple observations are obtained in action A120.

In this example, the criterion relates to the angle, or direction of the path. This may be performed in order to filter out, or filter in, paths moving in a range of specific angles, or directions. In some cases, there may be noise that follows a specific geometric/spatial pattern, which will give rise to path with a specific movement direction in a region of the sensor's FoV. One example is a vertical truss or pole moving in the wind, which can give rise to vertical paths in a region of the FoV. Another example can be a road with traffic that moves in a very specific direction.

For this region tracking condition, paths are filtered by first computing the angle v, between a directional vector of the path a, and the directional vector of the direction that shall be filtered in or out b, by calculating the dot product between these two vectors.

$$a \cdot b = \vert a \vert \vert b \vert cos v$$

If this angle, v, is less than an angle threshold, T, the path is discarded or kept, depending on if the direction shall be filtered in or filtered out.

In this context, it may be noted that the directional vector of the path may be given by a difference vector between the last added observation and its predecessor. However, sometimes a more sophisticated approach may be applied using a predictive method, e.g., by use of a Kalman filter, polynomial approximations or the like.

According to two further examples of this region tracking condition, there is a unidirectional example, where the sign of the angle is considered—if the sign of the angle is negative, the path is kept—and the bidirectional example, where only the absolute value of the angle is considered: The bidirectional example may be useful to filter out a branch with leaves that oscillates, such as swings back and forth, or the like, in the wind.
Unidirectional: If a·b<|a∥b| cos(T) (expression 1) then discard path.
Bidirectional: If |a·b|<a∥b| cos(T) (expression 2) then discard path.

For reasons of computational efficiency, expression 2 above may be calculated as |a·b|²<|a|²|b|² cos²(T) to avoid square root calculations, under the constraint that T<90 degrees. Similarly, expression 1 may be rewritten to avoid square root calculations.

In this example, the criterion relates to jaggedness of the path. This means that the criterion puts a limit on the jaggedness of the path. If the tracked object can be assumed to be in free flight, with only external forces, e.g., due to gravity, wind, friction etc., acting on it, the path of the object can be assumed to be smooth, i.e., no sudden directional changes from one observation to another shall be expected. In the case of sports projectile tracking, such as tracking of a golf ball, this can be assumed to be the case when the ball travels in the air without contact with the ground, e.g., when a background around the sports projectile resembles the sky. The sky can be assumed to be white, blue or have a typical appearance. Noise and objects which are not only affected by external forces (such as birds and insects) are not limited in the same way in their movement pattern. Similarly, a golf ball bouncing or rolling on the ground is not in free flight and therefore might move in a more stochastic manner. Further, the background of such sports projectile would usually not resemble the sky. It is therefore beneficial to impose a limit on the jaggedness of the path, but only in certain parts of the FoV of the sensor.

The jaggedness can be estimated in many ways, such as by counting the number of directional changes higher than a certain number of degrees between adjacent observations, over the time of the path, or as a frequency. Another example would be to calculate the shortest path between two observations, such as points, in the path and compare it to the actual path the object took between those two observations—the greater the difference—the more “jaggedness”. The two observations shall have at least one observation, or point, between themselves, i.e., the two observations shall not be directly adjacent.

The region tracking condition can comprise an instruction that the observation, comprising a blob, shall be discarded when a blob brightness, i.e., a brightness of the blob, is less than a background at the blob. E.g., an average brightness of brightness of pixels at the position of the blob, e.g., for a number of preceding image frames. In this manner, it may be avoided that shadows are interpreted as being moving sports projectiles. The number of preceding image frames may be dynamic or predetermined. When a predetermined number is used, e.g., the brightness of the background at a given position may be an average of the brightness for the last thirty-two image frames, or other suitable number, at the position(s) given by the blob.

In some examples, the brightness of the blob is an aggregated value, such as an average of the brightness of the pixels in the blob. In some examples, the brightness of the blob includes a collection of brightness values, i.e., one brightness value for each pixel in the blob.

When determining whether the blob brightness is less than the background brightness, it may be that each value of the collection of brightness values is compared to the background brightness.

Expressed differently, the instruction implies that the observation shall have a brightness higher than the background, i.e., not track shadows of objects. If the sensor is a camera, the observation might be a deviation of a pixel, compared to its background. This deviation can either be brighter or darker than the background. Depending on the environment, such as the absolute brightness of the background, and the location of light sources (including the sun), compared to the tracked object, despite the object itself having a certain color, it can usually be either darker or lighter than the background. There are however situations where it's reasonable to assume that a golf ball moving in the image will result in a positive deviation in the pixel, i.e., it is brighter when the golf ball passes over the pixel. This could for example be the case if there is a lot of light in the environment, and the background includes, or depicts, ground known to be darker than the golf ball. In such situations, it makes sense to apply a policy that requires an observation to be a positive deviation, compared to the background i.e., the pixel of the observation becomes brighter.

It is fairly trivial to describe how to process the source frame and create a binned and a clipped frame out of it. Unfortunately, these frames need to be reunited again into one list of points-of-interest (“blobs”).

By using 2×2 binning and ROI in combination, the present invention achieves a 50% reduction of bandwidth, neither sacrificing the launch precision nor the distant resolution.

For example, if one assumes that the source sensor has a native resolution of 3200×2200 pixels and supports a framerate of 120 fps with a precision of 12 bits per pixel. If these numbers are multiplied, one can see that there is a need to transmit 10.2 Gbit/s (excluding overhead).

If instead, for each frame in the source video, one transmits a 1600×1100 pixels (2×2) full-sensor binned image along with a 1600×1100 pixels (ROI) clipped image, then one can cover both the fast and the distant use case but only transmit

$$2 * 1600 * 1100 * 12 * 120 = 5.1 Gbit / s .$$

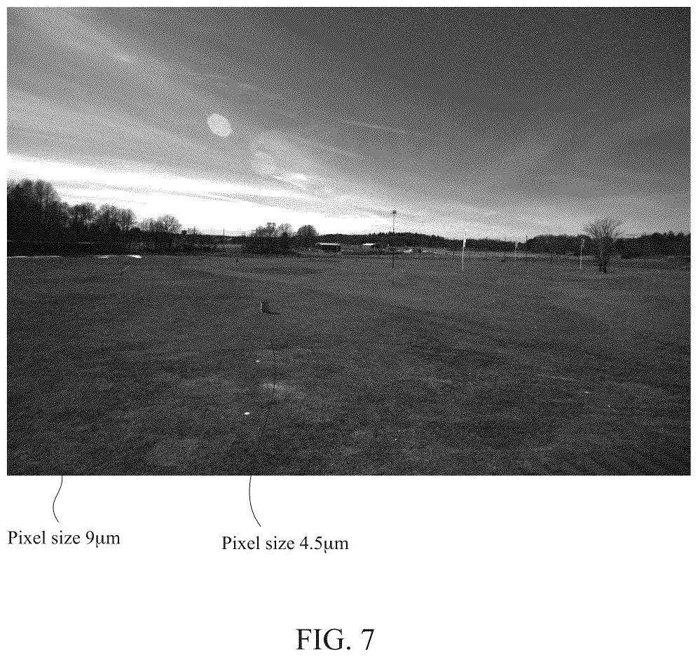

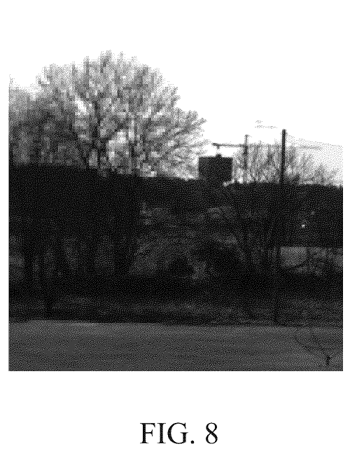

An example with an image is shown in FIGS. 7-8.

FIG. 5 is a block diagram of a computing apparatus 110. The computing apparatus 110 comprises of a processing unit 501, which has a processing circuit 504, memory 502, an obtaining unit 510, a determining unit 520, an evaluating unit 530, a retaining unit 540, a discarding unit 550, and an input/output (I/O) unit 506. Also included is a computer program 503 in communication with the memory 502 and a carrier 505.

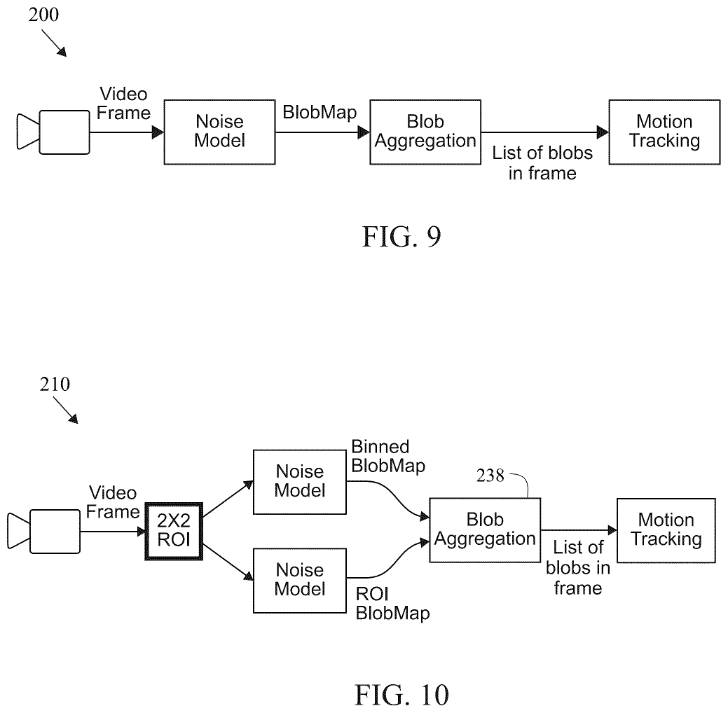

The standard segmentation algorithm can be summarized with the block diagram 200 shown in FIG. 9.

When the input is split, as shown in the block diagram 210 in FIG. 10, a step is needed that recombines the inputs. Since there are exactly two frames emitted for each input frame, these can be aggregated again in the blob aggregation step 238.

The updated blob aggregation step 238 will do both, labeling of connected components as described in the blob generation, and merging of the BlobMaps on the fly.

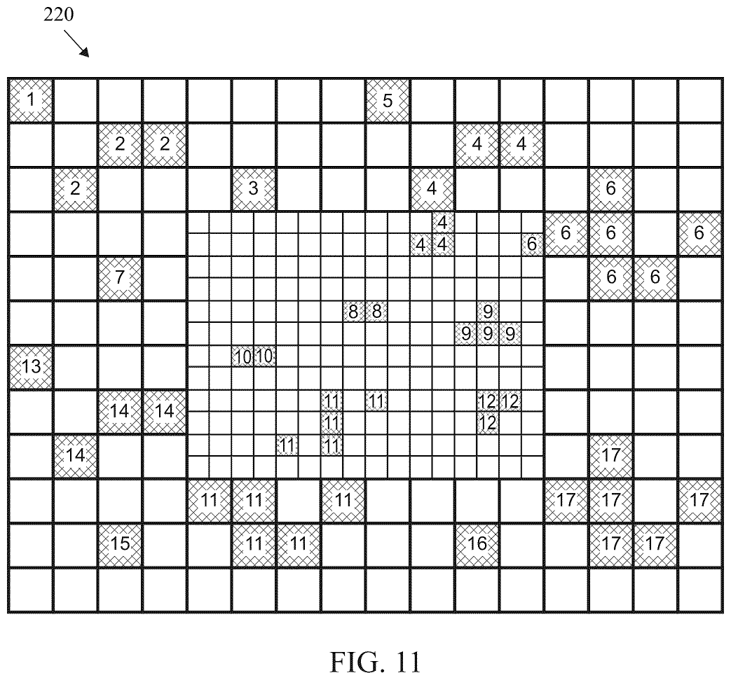

FIG. 11 illustrates the “binned” cells 220, which are processed as before and merged with any adjacent cells whose pixels are outside their normal interval. The ROI cells, however, are processed in 2×2 chunks. So if a 2×2 chunk contains one or more blob cells, the entire 2×2 chunk will be considered part of a blob and can in turn be merged to adjacent cells.

Any collected data, such as the weighted average coordinates and the aggregated brightness metric are collected based on the original native pixels. This allows us to keep the enhanced spatial information, while still allowing us to do nearest-neighbor searches based on the large cells.

Because of this design, some gaps in the generated blobs will be tolerated. For instance, the cells that make up blob “11” in FIG. 11 are not all adjacent, but they all belong to chunks or large cells that are adjacent.

In this step, the two versions of the original frame have now been used to generate one list of points of interest that is passed on to the 2-D tracker.

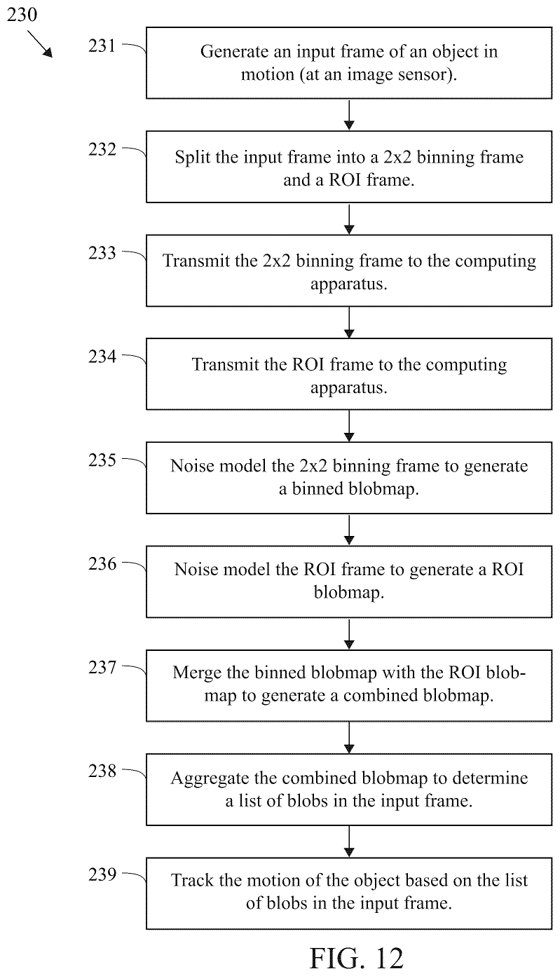

FIG. 12 is a flowchart 230 for a method for bandwidth reduction in a motion tracking apparatus. In the first step 231, from the sensor, an input frame of an object in motion is generated. At step 232, the input frame is split into a 2×2 binning fame and a ROI frame. At step 233 and step 234, the 2×2 binning frame and the ROI frame is sent to a computing apparatus. Steps 235 is noise modelling the 2×2 binning frame to generate a binned blobmap and step 236 is noise modelling the ROI frame to generate a ROI blobmap. The two generated blobmaps are then merged to generate a combined blobmap in step 237. The combined blobmap is then aggregated in step 238 to determine a list of blobs in the input frame. The connected components are also labeled during step 238. Based on the list of blobs, the motion of the object is tracked in step 239.

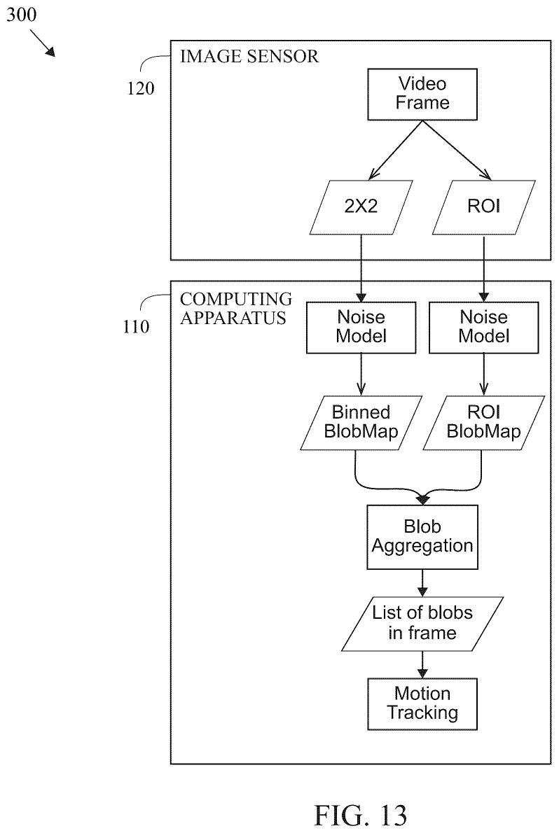

FIG. 13 shows a system 300 for bandwidth reduction in motion tracking. The system 300 includes an image sensor 120 and a computing apparatus 110. The image sensor 120 in the system 300 is configured to do the following steps of the method of FIG. 12: steps 231-234. The computing apparatus 110 of the system 300 is configured to do the steps of the method of FIG. 12: steps 235-239.

It is believed that the process of clipping+subsampling the high-resolution video streams, and running the noise modelling on each of the resulting streams in parallel is innovative. The connected-component-labeling of mixed-size pixels and the technique of treating these as 2×2 cells is also innovative.

Thirkettle et al., U.S. Pat. No. 7,056,221 for a Ball Collection Arrangement, is hereby incorporated by reference in its entirety.

Golliffe et al., U.S. Pat. No. 7,059,974 for Golf Balls With Impact Resistant Identification Device, is hereby incorporated by reference in its entirety.

Thirkettle et al., U.S. Pat. No. 7,160,196 for an Identification Device, is hereby incorporated by reference in its entirety.

Thirkettle et al., U.S. Pat. No. 7,337,965 for a Ball Identifying Device, is hereby incorporated by reference in its entirety.

Savarese et al., U.S. Pat. No. 7,691,009 for Apparatus And Methods Relating To Findable Balls, is hereby incorporated by reference in its entirety.

Savarese et al., U.S. Pat. No. 7,766,766 for Methods And Apparatus Relating To Findable Balls, is hereby incorporated by reference in its entirety.

Cheng, U.S. Pat. No. 7,806,777 for Automatically Adapting Virtual Equipment Model, is hereby incorporated by reference in its entirety.

Cheng, U.S. Pat. No. 7,847,808 for Photographic Mapping In A Simulation, is hereby incorporated by reference in its entirety.

Savarese et al., U.S. Pat. No. 8,002,645 for Apparatus, Methods And Systems Relating To Findable Balls, is hereby incorporated by reference in its entirety.

Cheng, U.S. Pat. No. 8,029,359 for Providing Offers To Computer Game Players, is hereby incorporated by reference in its entirety.

Forsgren, U.S. Pat. No. 8,077,917 for Systems And Methods For Enhancing Images in A Video Recording of A Sports Event, is hereby incorporated by reference in its entirety.

Caster et al., U.S. Pat. No. 9,132,326 for a System For Providing Loaner Clubs To Novice Golfers, is hereby incorporated by reference in its entirety.

Forsgren, U.S. patent Ser. No. 10/596,416 for a System And Method For Three Dimensional Object Tracking Using Combination of Radar And Image Data, is hereby incorporated by reference in its entirety.

Semsak et al., U.S. patent Ser. No. 10/799,770 for a RFID Golf Ball Testing Apparatus, is hereby incorporated by reference in its entirety.

Johansson et al., U.S. patent Ser. No. 10/898,757 for Three Dimensional Object Tracking Using Combination of Radar Speed Data And Two Dimensional Image Data, is hereby incorporated by reference in its entirety.

Forsgren et al., U.S. patent Ser. No. 11/335,013 for Motion Based Pre-Processing Of Two-Dimensional Image Data Prior To Three-Dimensional Object Tracking With Virtual Time Synchronization, is hereby incorporated by reference in its entirety.

Forsgren, U.S. Patent Publication Number 20200391077 for a System And Method For Three Dimensional Object Tracking Using Combination of Radar And Image Data, is hereby incorporated by reference in its entirety.

Johansson et al., U.S. patent Ser. No. 11/504,582 for Three Dimensional Object Tracking Using Combination of Radar Speed Data And Two Dimensional Image Data, is hereby incorporated by reference in its entirety.

Eriksson, U.S. patent Ser. No. 11/513,208 for Method For Determining Spin Of A Projectile, is hereby incorporated by reference in its entirety.

Hugmark et al., U.S. patent Ser. No. 11/644,562 for Trajectory Extrapolation And Origin Determination For Objects Tracked Flight, is hereby incorporated by reference in its entirety.

Forsgren, U.S. patent Ser. No. 11/697,046 for a System And Method For Three Dimensional Object Tracking Using Combination of Radar And Image Data, is hereby incorporated by reference in its entirety.

Hugmark et al., U.S. patent Ser. No. 11/771,957 for Trajectory Extrapolation And Origin Determination For Objects Tracked Flight, is hereby incorporated by reference in its entirety.

Levin, U.S. patent Ser. No. 11/409,411 for a Single Finger User Interface Camera Control, is hereby incorporated by reference in its entirety.

Johansson et al., U.S. patent Ser. No. 11/504,582 for Three Dimensional Object Tracking Using Combination of Radar Speed Data And Two Dimensional Image Data, is hereby incorporated by reference in its entirety.

Stroud, U.S. patent Ser. No. 11/779,809, for a Method And System Utilizing A Golf Shot API Proxy, is hereby incorporated by reference in its entirety.

Burdette, U.S. patent application Ser. No. 18/202,178, filed on May 25, 2023, for a Golf Ball Identification Apparatus And System, is hereby incorporated by reference in its entirety.

Burdette et al., U.S. Patent Publication Number 20220203178, for a Golf Ball Dispenser With Embedded Display Device, Separate Front waterfall And/Or Blower Assembly, is hereby incorporated by reference in its entirety.

Burdette et al., U.S. Patent Publication Number 20230338801, for a Galton Configuration In Golf Ball Receiving Apparatus And Systems, is hereby incorporated by reference in its entirety.

Ekstrom et al., U.S. patent Ser. No. 11/786,783 for Identifying A Location ForA Striker OfAn Object, is hereby incorporated by reference in its entirety.

Eriksson et al., U.S. patent Ser. No. 11/815,618 for Doppler Radar Coexistence, is hereby incorporated by reference in its entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention the following:

1. A method for bandwidth reduction in a motion tracking apparatus, the method comprising:
generating, at an image sensor, an input frame of an object in motion;
splitting the input frame into a 2×2 binning fame and a Region Of Interest (ROI) frame;
transmitting 2×2 binning frame to a computing apparatus;
transmitting the ROI frame to the computing apparatus;
noise modelling the 2×2 binning frame to generate a binned blobmap;
noise modelling the ROI frame to generate a ROI blobmap;
merging the binned blobmap with the ROI blobmap to generate a combined blobmap;
aggregating the combined blobmap to determine a list of blobs in the input frame; and
tracking the motion of the object based on the list of blobs in the input frame.

2. The method according to claim 1 further comprising labeling of a plurality of connected components during the aggregating step.

3. A system for bandwidth reduction in a motion tracking, the system comprising:
an image sensor;
a computing apparatus in communication with the image sensor;
wherein the image sensor is configured to generate an input frame of an object in motion;
wherein the image sensor is configured to split the input frame into a 2×2 binning fame and a Region Of Interest (ROI) frame;
wherein the image sensor is configured to transmit 2×2 binning frame to the computing apparatus;
wherein the image sensor is configured to transmit the ROI frame to the computing apparatus;
wherein the computing apparatus is configured to noise model the 2×2 binning frame to generate a binned blobmap;
wherein the computing apparatus is configured to noise model the ROI frame to generate a ROI blobmap;
wherein the computing apparatus is configured to merge the binned blobmap with the ROI blobmap to generate a combined blobmap;
wherein the computing apparatus is configured to aggregate the combined blobmap to determine a list of blobs in the input frame; and
wherein the computing apparatus is configured to track the motion of the object based on the list of blobs in the input frame.
